(19) United States
(12) Patent Application Publication
(10) Pub. No.: US 2026/0212332 A1
(43) Pub. Date: Jul. 23, 2026

(54) Cross-Platform Centralized / Decentralized Database Linkage System

(71) Applicant: SMT Web3, Inc., Carbondale, CO (US)

(72) Inventors: Tyler Moebius, Carbondale, CO (US); Lukas Fluri, Zug (CH); Gunther Thiel, Zug (CH)

(21) Appl. No.: 19/098,681

(22) Filed: Apr. 2, 2025

Related U.S. Application Data
(60) Provisional application No. 63/747,478, filed on Jan. 21, 2025.

(51) Int. Cl. G06Q 20/06; G06Q 20/36; G06Q 20/38

(52) U.S. Cl. CPC G06Q 20/0658; G06Q 20/36; G06Q 20/3825; G06Q 20/389; G06Q 2220/10

(57) ABSTRACT

A cloud computing system may include a database system storing user entries including identification data corresponding to user accounts, a communication interface in communication with an external database system storing database entries corresponding to a subset of the plurality of user accounts, an access system providing access to a private blockchain and a plurality of public blockchains, and a consent management system. The cloud computing system may be configured to facilitate interoperability and transactions between and across various external database systems and blockchains.

### CROSS-REFERENCE TO RELATED APPLICATIONS

This application claims the benefit under 35 U.S.C. § 119 (e) of U.S. Provisional Patent Application 63/747,478 (Attorney Docket No. SMRTP001P) by Moebius, et al., filed on Jan. 21, 2025, which is incorporated herein by reference in its entirety for all purposes.

### FIELD OF TECHNOLOGY

This patent application relates generally to database systems, and more specifically to linkages between various types of database systems.

### BACKGROUND

The linkage of database systems across different systems and entities presents significant technical challenges. For example, different companies may store information in different database system configurations. Issues such as security concerns, different application procedure interfaces, authentication and validation, cross-platform information tracking, and system interoperability preclude the easy exchange of data between and among these systems and other systems. Accordingly, improved techniques for cross-platform database linkage are needed.

### SUMMARY

In some embodiments, the techniques and mechanisms described herein relate to a cloud computing system including: a database system storing a plurality of user entries including identification data corresponding to a plurality of user accounts within the cloud computing system; a communication interface in communication with a plurality of external database systems, an external database system of the plurality of external database systems storing a plurality of database entries corresponding to a subset of the plurality of user accounts; an access system providing access to a private blockchain and a plurality of public blockchains, the private blockchain storing a plurality of wallets corresponding to the plurality of users, the access system being configured to mint a first one or more tokens of a first token type to a wallet of the plurality of wallets based on a value stored in a database entry of the plurality of database entries, the wallet and the database entry each corresponding to a designated user account of the plurality of user accounts, the access system being configured to update the value stored in the database entry upon minting of the one or more tokens, the access system being configured to convert a portion of the first one or more tokens to a second one or more tokens of a second token type, the access system being configured to transfer the second one or more tokens to a designated recipient located outside of the cloud computing system; and a consent management system configured to transmit a confirmation message to a client machine associated with the designated user account upon receiving a request to mint the first one or more tokens of the first token type, to receive from the client machine a cryptographic signature of the confirmation message, and to record the cryptographic signature in the private blockchain via the access system.

In some embodiments, the techniques and mechanisms described herein relate to a cloud computing system, where the access system is configured to store a plurality of auditing records on the private blockchain, the plurality of auditing records reflecting one or more transactions performed via the access system.

In some embodiments, the techniques and mechanisms described herein relate to a cloud computing system, where converting the portion of the first one or more tokens to the second one or more tokens includes determining that converting the portion of the first one or more tokens to the second one or more tokens does not violate one or more transfer exclusions restricting transfers of the first token type.

In some embodiments, the techniques and mechanisms described herein relate to a cloud computing system, where converting the portion of the first one or more tokens to the second one or more tokens includes determining a conversion rate, the conversion rate including a multiplier between the first token type and the second token type.

In some embodiments, the techniques and mechanisms described herein relate to a cloud computing system, where the conversion rate is specified by a service provider of the external database system.

In some embodiments, the techniques and mechanisms described herein relate to a cloud computing system, where converting the portion of the first one or more tokens to the second one or more tokens includes communicating with a decentralized stablecoin pool to determine the conversion rate.

In some embodiments, the techniques and mechanisms described herein relate to a cloud computing system, where the conversion rate is specified by a service provider of the external database system.

In some embodiments, the techniques and mechanisms described herein relate to a cloud computing system, where converting the portion of the first one or more tokens to the second one or more tokens of a second token type includes: (1) executing a token transfer function within a smart contract, and (2) executing a liability transfer function within the smart contract to transfer accounting liability for the first one or more tokens from a service provider of the external database system to the designated user account.

In some embodiments, the techniques and mechanisms described herein relate to a cloud computing system, where converting the portion of the first one or more tokens to the second one or more tokens of a second token type includes determining whether the wallet is storing an authorization token authorizing converting the first token type to the second token type and converting the portion of the first one or more tokens to the second one or more tokens upon determining that the wallet is storing the authorization token.

In some embodiments, the techniques and mechanisms described herein relate to a cloud computing system, where minting the first one or more tokens of the first token type includes: (1) executing a minting function within a smart contract, and (2) executing a liability transfer function within the smart contract to transfer accounting liability for the first one or more tokens from a service provider of the external database system to the designated user account.

In some embodiments, the techniques and mechanisms described herein relate to a cloud computing system, where transferring the second one or more tokens to the designated recipient located outside of the cloud computing system includes transferring the second one or more tokens to an omnibus wallet controlled by cloud computing system and transferring the second one or more tokens from the omnibus wallet to the designated recipient.

In some embodiments, the techniques and mechanisms described herein relate to a cloud computing system, where the second one or more tokens are stored on a public blockchain.

In some embodiments, the techniques and mechanisms described herein relate to a cloud computing system, where the second token type is a non-fungible token.

In some embodiments, the techniques and mechanisms described herein relate to a method implemented in a cloud computing system, the method including: storing a plurality of user entries including identification data corresponding to a plurality of user accounts in a database system within the cloud computing system; conducting communications with a plurality of external database systems via a communication interface, an external database system of the plurality of external database systems storing a plurality of database entries corresponding to a subset of the plurality of user accounts; accessing a private blockchain and a plurality of public blockchains via an access system, the private blockchain storing a plurality of wallets corresponding to the plurality of users, the access system being configured to mint a first one or more tokens of a first token type to a wallet of the plurality of wallets based on a value stored in a database entry of the plurality of database entries, the wallet and the database entry each corresponding to a designated user account of the plurality of user accounts, the access system being configured to update the value stored in the database entry upon minting of the one or more tokens, the access system being configured to convert a portion of the first one or more tokens to a second one or more tokens of a second token type, the access system being configured to transfer the second one or more tokens to a designated recipient located outside of the cloud computing system; and communicating with a client machine associated with the designated user account via a consent management system, where the communication includes transmitting a confirmation message to the client machine upon receiving a request to mint the first one or more tokens of the first token type, receiving from the client machine a cryptographic signature of the confirmation message, and recording the cryptographic signature in the private blockchain via the access system.

In some embodiments, the techniques and mechanisms described herein relate to a method, where converting the portion of the first one or more tokens to the second one or more tokens of a second token type includes: (1) executing a token transfer function within a smart contract, and (2) executing a liability transfer function within the smart contract to transfer accounting liability for the first one or more tokens from a service provider of the external database system to the designated user account.

In some embodiments, the techniques and mechanisms described herein relate to a method, where converting the portion of the first one or more tokens to the second one or more tokens of a second token type includes determining whether the wallet is storing an authorization token authorizing converting the first token type to the second token type and converting the portion of the first one or more tokens to the second one or more tokens upon determining that the wallet is storing the authorization token.

In some embodiments, the techniques and mechanisms described herein relate to a method, where minting the first one or more tokens of the first token type includes: (1) executing a minting function within a smart contract, and (2) executing a liability transfer function within the smart contract to transfer accounting liability for the first one or more tokens from a service provider of the external database system to the designated user account.

In some embodiments, the techniques and mechanisms described herein relate to one or more non-transitory computer readable media having instructions stored thereon for performing a method implemented in a cloud computing system, the method including: storing a plurality of user entries including identification data corresponding to a plurality of user accounts in a database system within the cloud computing system; conducting communications with a plurality of external database systems via a communication interface, an external database system of the plurality of external database systems storing a plurality of database entries corresponding to a subset of the plurality of user accounts; accessing a private blockchain and a plurality of public blockchains via an access system, the private blockchain storing a plurality of wallets corresponding to the plurality of users, the access system being configured to mint a first one or more tokens of a first token type to a wallet of the plurality of wallets based on a value stored in a database entry of the plurality of database entries, the wallet and the database entry each corresponding to a designated user account of the plurality of user accounts, the access system being configured to update the value stored in the database entry upon minting of the one or more tokens, the access system being configured to convert a portion of the first one or more tokens to a second one or more tokens of a second token type, the access system being configured to transfer the second one or more tokens to a designated recipient located outside of the cloud computing system; and communicating with a client machine associated with the designated user account via a consent management system, where the communication includes transmitting a confirmation message to the client machine upon receiving a request to mint the first one or more tokens of the first token type, receiving from the client machine a cryptographic signature of the confirmation message, and recording the cryptographic signature in the private blockchain via the access system.

In some embodiments, the techniques and mechanisms described herein relate to one or more non-transitory computer readable media, where converting the portion of the first one or more tokens to the second one or more tokens of a second token type includes: (1) executing a token transfer function within a smart contract, and (2) executing a liability transfer function within the smart contract to transfer accounting liability for the first one or more tokens from a service provider of the external database system to the designated user account.

In some embodiments, the techniques and mechanisms described herein relate to one or more non-transitory computer readable media, where converting the portion of the first one or more tokens to the second one or more tokens of a second token type includes determining whether the wallet is storing an authorization token authorizing converting the first token type to the second token type and converting the portion of the first one or more tokens to the second one or more tokens upon determining that the wallet is storing the authorization token.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and computer program products for database linkage. These drawings in no way limit any changes in form and detail that may be made by one skilled in the art without departing from the spirit and scope of the disclosed implementations.

FIG. 1 illustrates an example of a configuration of computing systems, provided in accordance with one or more embodiments.

FIG. 2 provides a more detailed view of the platform, configured in accordance with one or more embodiments.

FIG. 3 illustrates a smartchain access system, configured in accordance with one or more embodiments.

FIG. 4 illustrates a user identity and consent system, configured in accordance with one or more embodiments.

FIG. 5 illustrates an example of a set of balances entries for a user, configured in accordance with one or more embodiments.

FIG. 6 illustrates one example of a computing device.

FIG. 7 illustrates a method for enrolling a partner in a token management system, performed in accordance with one or more embodiments.

FIG. 8 illustrates a method of enrolling a user in a token management system, performed in accordance with one or more embodiments.

FIG. 9 illustrates a method for points conversion, performed in accordance with one or more embodiments.

FIG. 10 illustrates a method for converting tokens stored in the token management system to points stored in a centralized points balance system member account.

FIG. 11 illustrates a method of coordinating communication with a payment processor system, configured in accordance with one or more embodiments.

FIG. 12 illustrates a method of coordinating communication with a payment card system, performed in accordance with one or more embodiments.

FIG. 13 illustrates a method of redeeming a token-gated offer, performed in accordance with one or more embodiments.

FIG. 14 illustrates a token conversion method, performed in accordance with one or more embodiments.

FIG. 15 illustrates a token transfer method, performed in accordance with one or more embodiments.

### DETAILED DESCRIPTION

### Introduction

The linkage of database systems across different systems and entities presents significant technical challenges. For example, consider the different systems used by companies to track customer interactions. Companies often award customers with loyalty tokens based on various considerations. In general, companies would prefer to increase the value of such tokens by rendering them applicable in a variety of contexts to exchange for goods, services, and/or tokens issued by other companies. However, the tokens are stored in disparate systems with different table configurations. Issues such as security concerns, uncertain exchange rates, cross-platform balance tracking, and system interoperability preclude the easy exchange of data between and among these systems.

The difficulties of system interoperability and security are particularly pressing in the financial sector, where privacy, security, and fungibility are paramount. Accordingly, one set of payment management systems is centralized and based on exchange of fiat currency, including elements such as credit and debit card issuers, payment processors, merchants, and card holders, allowing for centralized management of balances, authorization, verification, and communication. Another set of payment management systems, such as Bitcoin, is entirely decentralized and based on distributed public trust ledgers. However, neither system is easily interoperable with existing points issuer systems.

Some conventional approaches for addressing the challenges related to system linkages have involved systems that are entirely centralized. For example, different participant database systems can be explicitly linked to a central database, which then acts as a single source of information. However, such conventional approaches are problematic for various reasons. For example, fully centralized approaches typically require tight linkages between the central database and the participant systems. As another example, fully centralized approaches rely on centralized record keeping, placing significant trust in the service provider of the centralized system.

Some conventional approaches for addressing the challenges related to system linkages have involved systems that are entirely decentralized. For example, points issuers may issue blockchain tokens instead of conventional loyalty points. However, such fully decentralized processes also present various problems. For example, many fully decentralized systems require points issuers to manage their own blockchain tokens, which is administratively difficult and can lead to various security issues. That is, a fully decentralized system conventionally requires the point issuer to manage a complex, technical interface with the decentralized system.

The difficulty in overcoming these technical difficulties is evident in part from the significant advantages obtained by linking these disparate database systems. Loyalty programs are widely used to incentivize customer engagement. However, traditional loyalty programs face challenges of poor redemption and utility of points due related to interoperability, liability management, and transparency considerations. Businesses often struggle to account for loyalty point liabilities on their balance sheets, while users face restrictions on paying with points, redeeming or transferring points between programs. Existing systems lack an effective method to link loyalty programs through an interoperable point network and transfer liability from businesses to users in a way that is transparent, auditable, and compliant with accounting standards.

According to various embodiments, described herein are systems and methods for providing a centralized/token management system. The centralized/token management system provides a single point of access (i.e., centralization) for connecting individual points issuer database systems with a unified blockchain-based exchange (i.e., decentralization). The centralized/token management system may be used to provide a blockchain-based interoperable pay with points loyalty network that spans multiple issuer systems and system configurations. The system facilitates the conversion of loyalty points into tokens (e.g., ERC-20 tokens), enables those tokens to be exchanged into other tokens or fiat and facilitates the seamless transfer of liability from businesses to users, and incorporates advanced smart contract mechanisms for exclusions, multipliers, consent recording. This approach provides accounting compliance, transparency, and scalability across loyalty ecosystems.

In some embodiments, systems and methods described herein provide for operations such as: (1) converting loyalty points from multiple loyalty programs into blockchain-based tokens (e.g., ERC-20 tokens); (2) transferring liability for loyalty points from the company's balance sheet to the blockchain and ultimately to the user's wallet upon token issuance; (3) capturing and recording the user's explicit consent to accept liability using cryptographic wallet signatures; (4) enforcing advanced token rules, such as exclusions (preventing swaps between specific tokens) and multipliers (enhancing token value during swaps); (5) facilitating token swaps using liquidity pools to dynamically determine conversion rates and/or (6) enabling pay with points by allowing users to convert points for stablecoins that can be used at the time of purchase.

According to various embodiments, the system leverages blockchain technology to ensure transparency, compliance, and interoperability across loyalty programs while empowering users with greater flexibility and control over their rewards.

In some embodiments, the system supports on-chain liability transfer. Loyalty point liabilities may be transferred from the company's balance sheet to the blockchain and then to the user.

In some embodiments, the system supports user consent recording. For example, explicit user consent to accept liability may be captured and verified via an on-chain method, using cryptographic wallet signatures.

In some embodiments, the system supports token swap governance. For example, smart contract rules support exclusions and multipliers, ensuring compliance with program-specific policies along with global regulatory and compliance requirements.

In some embodiments, token swap exclusions may be supported. For instance, specific tokens can be prevented from being swapped with others. Exclusions may be stored in the smart contract as metadata and enforced during swaps. For example, an exclusion may prevent program A tokens (LPT_A) from being swapped with program B tokens (LPT_B).

In some embodiments, token swap multipliers may be supported. Multipliers can enhance the value of specific tokens during swaps. Multipliers may be dynamically applied based on predefined rules, for instance rules set by the source program for the tokens. For example, a 1.5× multiplier may be applied when swapping Program A tokens (LPT_A) to Program C tokens (LPT_C).

In some embodiments, the system provides an interoperable loyalty network. For example, a decentralized ecosystem allows seamless token conversion, swapping, and interoperability across loyalty programs and the ability for those tokens to be used in the form of payment whenever the merchant bank or processor accepts it. For instance, points may be accepted by any merchant that employs a processor that accepts stablecoins, such as Stripe or Paypal.

In some embodiments, the system provides real-time accounting integration. For example, blockchain-based liability tracking ensures transparency and compliance with accounting standards.

According to various embodiments, an example workflow is as follows. First the user signs a message acknowledging liability for the points being converted to a loyalty point (LP) token. Next the loyalty program transfers liability for points to the blockchain, for instance using the transferLiability function. The smart contract verifies the signature and records the consent. Then, the smart contract mints tokens (e.g., ERC-20 tokens) and issues them to the user's wallet. Finally, the user swaps tokens via a liquidity pool, while exclusions and multipliers are enforced during the swap. The use then has the ability to either (a) transfer or gift their loyalty point tokens to another wallet (b) exchange those LP tokens for another LP token to get a multiplier on the reward or (c) swap the LP token for a stablecoin that can be used at a time of purchase.

In some embodiments, a smart contract may include metadata elements and functions to enforce several post-conversion implications. For the company, liability for the points is removed from the company's balance sheet upon conversion. The company's obligation is completed, and it only interacts with the tokens if specified under different contractual terms. For the user, users gain full ownership of the tokens, taking on all risks and rewards. tokens can be used within the ecosystem, traded, or held based on their utility and market demand. Thus, by embedding these metadata elements and functions, the smart contract ensures a clear, auditable transfer of liability from the company to the end user, minimizing legal and financial ambiguity.

In some embodiments, to clearly transfer liability from the company to the end user when loyalty points are converted into blockchain-based tokens, the smart contract includes specific metadata and mechanisms that establish: (1) ownership, by explicitly transferring ownership of the tokens to the user; and (2) obligation release, by explicitly stating that the company has no further obligation related to the tokens.

In some embodiments, the system may support liability retention on a company's balance sheet. For example, loyalty points remain a liability on the program's balance sheet until redeemed by the user for tokens via liquidity pools or directly redeemed (e.g., for digital objects, badges, or tokenized sweepstakes entries).

In some embodiments, the system may support dynamic liability reduction. For example, upon user redemption, the point liability is reduced immediately in real-time. For liquidity pool conversions, liability can be transferred to the blockchain and reflected in token issuance. For non-cost-based redemptions, liability can be extinguished immediately upon direct conversion.

According to various embodiments, techniques and mechanisms described herein provide for systems supporting loyalty programs. For example, a blockchain-based system may support dynamic conversion of loyalty points into tokens via liquidity pools or direct redemption. The system may provide mechanisms for managing point liability on program balance sheets until user redemption, transferring liability upon consent, and/or supporting token-based interoperability for digital objects, sweepstakes entries, or other non-cost-based conversions.

In some embodiments, a blockchain-based interoperable loyalty network manages liability for loyalty points dynamically, integrating real-time point-to-token conversion via liquidity pools or direct redemption mechanisms.

In some embodiments, the system may support dynamic liability management. Liability for unredeemed loyalty points remains on the program's balance sheet until points are redeemed for tokens, digital objects, or other entitlements.

In some embodiments, the system may support liquidity pool-based conversion. For example, users can swap loyalty tokens (LPT_A) into other tokens (LPT_B), stablecoins, or other ERC-20 tokens through liquidity pools that dynamically determine conversion rates.

In some embodiments, the system may support direct redemption for non-liquidity-based conversions. For example, users can redeem points directly for non-cost-based items, such as badges, digital objects, or tokenized sweepstakes entries, bypassing the liquidity pool and enabling immediate reduction of liability from the program's balance sheet.

In some embodiments, the system may support on-chain liability transfer. For example, liability is transferred from the program to the user upon token issuance or redemption, with real-time accounting and compliance records.

In some embodiments, the system may support user consent recording. For example, explicit user consent to accept liability is captured via cryptographic wallet signatures and stored on-chain for auditability.

In some embodiments, the system may support customizable token rules. Such rules may provide mechanisms for exclusions, multipliers, and metadata governance during token swaps and conversions.

### System Architecture

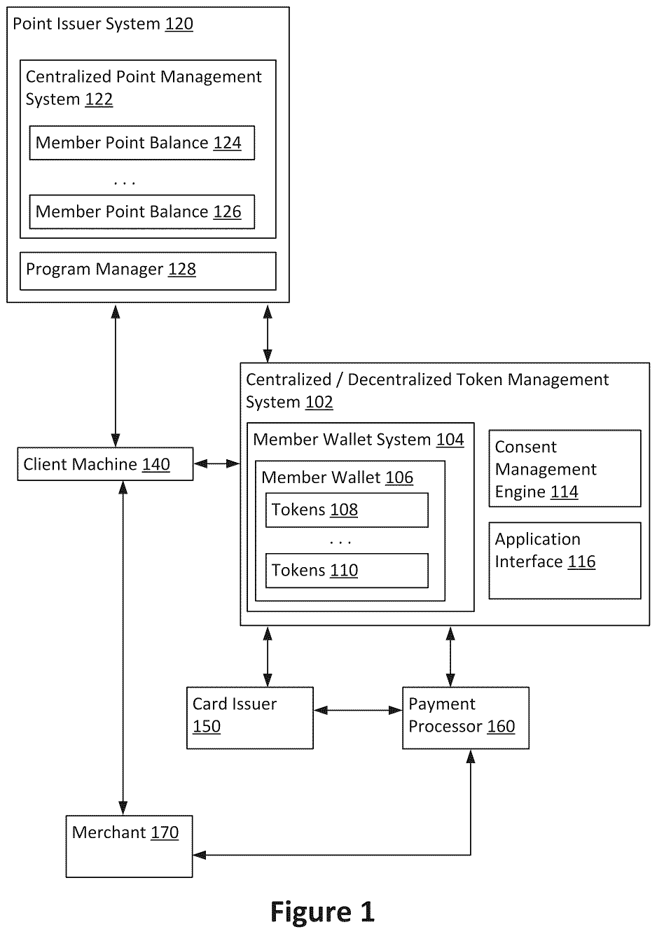

FIG. 1 illustrates an example of a configuration of computing systems, provided in accordance with one or more embodiments. The configuration shown in FIG. 1 includes a centralized/token management system 102, which includes a user wallet system 104, a consent management engine 114, and an application interface 116. The user wallet system 104 includes a user wallet 106, which includes the tokens 108 through 110. The token management system 102 is in communication with a points issuer system 120, which includes a point management system 122 and a program manager 128. The point management system 122 includes point balancers 124 through 126 for various users. The token management system 102 is also in communication with a card issuer 150, a payment processor 160, and a client machine 140. The client machine and payment processor 160 are also in communication with a vendor 170.

According to various embodiments, the centralized/token management system 102 is decentralized in that it supports the interoperability of points balances issued by potentially numerous different issuers. The points balances may be stored as values in potentially numerous different database systems or may be converted to tokens that may be stored on a private blockchain or in any of potentially numerous different blockchains. The centralized/token management system 102 is centralized in the sense that it provides a single point of access for a points issuer administrator or other participant to manage this diversity of systems and the interoperability between them.

According to various embodiments, the point issuer may be a merchant such as Delta Airlines. The point issuer may maintain a loyalty point program in which it awards points for various customer interactions.

In some embodiments, the points issuer system 120 may be located within the centralized/token management system 102. For instance, the centralized/token management system 102 may manage the points issuer system 120 on behalf of the points issuer.

In some embodiments, the points issuer system 120 may be located outside the centralized/token management system 102. For instance, the points issuer system 120 may be a database system controlled by the points issuer or may be a third-party system. In either case, such a system may be accessed over a network via an interface.

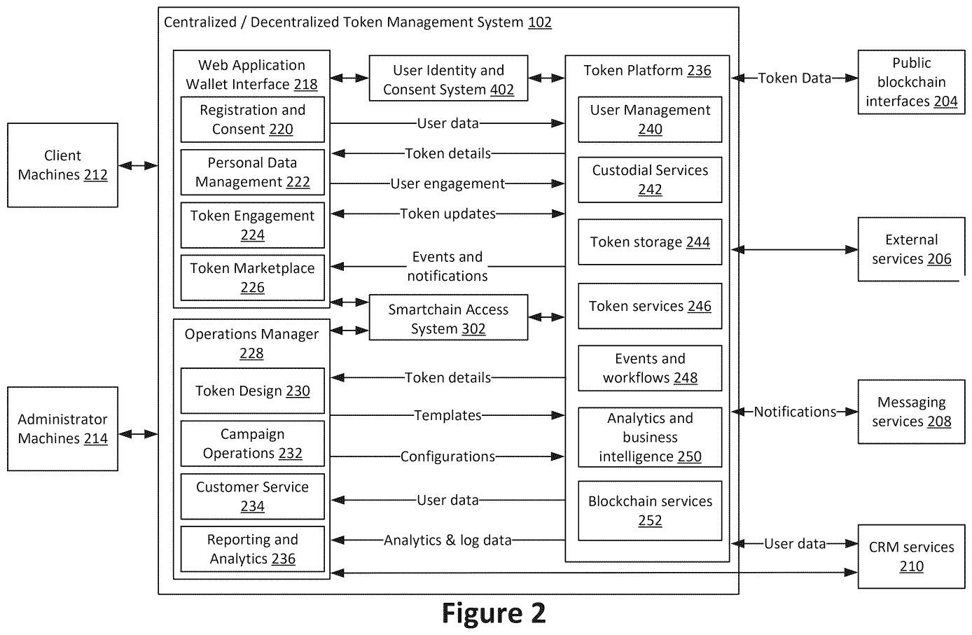

In some embodiments, an enrollment process may be implemented in which a point issuer enrolls in the token management platform. During such enrollment, the point issuer provides access to the point issuer's point management system 122 to the token management system 102. For instance, the point issuer system 120 may provide authentication credentials for the token management system 102 to access the point management system 122. The access may allow the token management system 102 to perform operations such as reading user point balances and deducting points from the point values. The centralized/token management system 102 is described in additional detail with respect to FIG. 2.

As part of the enrollment process, the point issuer system may contact its members and provide them with an opportunity to voluntarily enroll in the token management system. Alternatively, members may be auto-enrolled. Voluntary enrollment may take the form of a message containing a link for accessing the token management platform.

In some embodiments, when a user clicks on the link, they may be provided with an opportunity to access the token management system 102 via the application interface 116. Access may take the form of a native application, a web application, or some other access mechanism. The token management platform may then determine whether the user is already associated with an existing wallet, for instance by having enrolled in the platform via a different point issuer system. If the user is not associated with an existing wallet, then one may be created for the user.

In some embodiments, the user wallet may be a custodial web3 wallet in which the token management system 102 holds the private keys. Such a configuration allows the token management platform to perform actions on behalf of the user.

According to various embodiments, the point issuer may specify one or more configuration parameters. Examples of such parameters may include: (1) a list of in-network vendors, (2) a conversion rate for converting points to loyalty tokens, (3) a multiplier for additional point value when purchasing from in-network vendors, (4) a penalty for converting points to stablecoins or out-of-network vendors, and/or (5) any of a variety of other parameters.

In some embodiments, the point issuer and/or the user may specify that an enrolled user's loyalty points are immediately converted to tokens, shifting the liability to the user. Alternatively, the point issuer and/or the user may specify that an enrolled user's loyalty points remain as points and are converted to tokens upon request.

In some embodiments, the system may support various pay-with-points processes. For example, a user may first link a debit card or credit card with the token management system 102 via a card issuer 150. Then, the user may redeem loyalty points for statement credits to reimburse purchases made with the card. As another example, a user may directly pay a vendor with points via a payment processor 160 that accepts stablecoins. In such a configuration, a purchase request may result in loyalty points being converted to stablecoins via a liquidity pool, and the stablecoins then being provided to the payment processor.

According to various embodiments, although various elements in FIG. 1 are shown in the singular for the purpose of illustration, multiples of such elements may exist. For instance, the system may include multiple point issuer systems, client machines, user wallets, card issuers, vendors, payment processors, and the like.

FIG. 2 provides a more detailed view of the platform, configured in accordance with one or more embodiments. The centralized/token management system 102 may interact with one or more blockchain interfaces 204, external services 206, messaging services 208, CRM services 210, client machines 212, and/or administrator machines 214. The token management system may be implemented in one or more cloud platforms, such as Amazon's AWS.

According to various embodiments, the token management system 102 provides an automated, transparent mechanism for managing points via multiple point systems. Users can take points that are not otherwise interoperable and can perform operations such as swapping them, using them for payments, and otherwise treating them as immediately liquid. At the same time, the token management system 102 supports compliance with various regulatory frameworks related to liability, accounting, and other such considerations.

According to various embodiments, the token management system 102 is blockchain-agnostic. For example, a merchant and/or points issuer may bring to the token management system 102 their own token specific to a blockchain, which may or may not be the blockchain employed by the system. As another example, a merchant and/or points issuer may bring to the token management system 102 a loyalty program that is not backed by blockchain, and may operate in the absence of blockchain backing. As yet another example, a merchant and/or points issuer may bring to the token management system 102 a loyalty program that is not backed by blockchain, and may create such backing via the token management system 102. Points can be hosted on the blockchain, and/or within the cloud computing environment backing the token management system 102.

In some embodiments, the token management system 102 may support various minting capabilities. For example, a merchant and/or points issuer may choose to back every point to a token on the blockchain. As another example, the merchant and/or points issuer may decide instead to provide the ability for an end user to mint tokens themselves and pay the gas fees.

According to various embodiments, a user's wallet includes an inventory of what the user owns. The wallet is centralized within the token management system 102. The wallet may include various types of tokens, which may be blockchain tokens, non-blockchain tokens, fungible tokens, and/or non-fungible tokens. The tokens can then be minted onto various chains. For instance, tokens associated with a brand-specific loyalty program may be minted onto a chain specified by the brand/merchant.

In some embodiments, a user's wallet may be a custodial wallet managed by the token management system 102. In such a configuration, the token management system 102 manages the public/private key pair on the behalf of the user enabling certain functions and capabilities such as maintaining and managing the wallet via passwords and authentication (e.g., Google authentication). Such a configuration allows the system to act on the behalf of the user for certain blockchain functions such as the minting or swapping of tokens. The wallet and the custodian services provide ease of use for both end-users and program managers.

According to various embodiments, various users, creative developers and marketers, customer service representatives, and/or other individuals may interact with the token management system 102 via various remote computing devices such as the client machines 212 and the administrator machines 214.

The centralized/token management system 102 includes a web application wallet interface 218. In some embodiments, the web application wallet interface 218 facilitates interactions between users and their wallets, hence providing indirect access to one or more token issuer systems. For example, the web application wallet interface 218 may provide access to functions such as registration and consent 220, personal data management 222, token engagement 224, and a token marketplace 226.

The token management system 102 also includes an operations manager 228 that facilitates various developer-related operations by managers and administrators. The operations manager 228 provides access to functions such as token design 230, campaign operations 232, customer service 234, and reporting and analytics 236.

According to various embodiments, both the web application wallet interface 218 and operations manager 228 may provide their services by accessing the token platform 236, which facilitates interactions with both internal and external services. For example, the token platform 236 provides features such as user management 240, custodial wallet services 242, token storage 244, token services 246, events and workflows 248, analytics and business intelligence 250, and/or blockchain services 250.

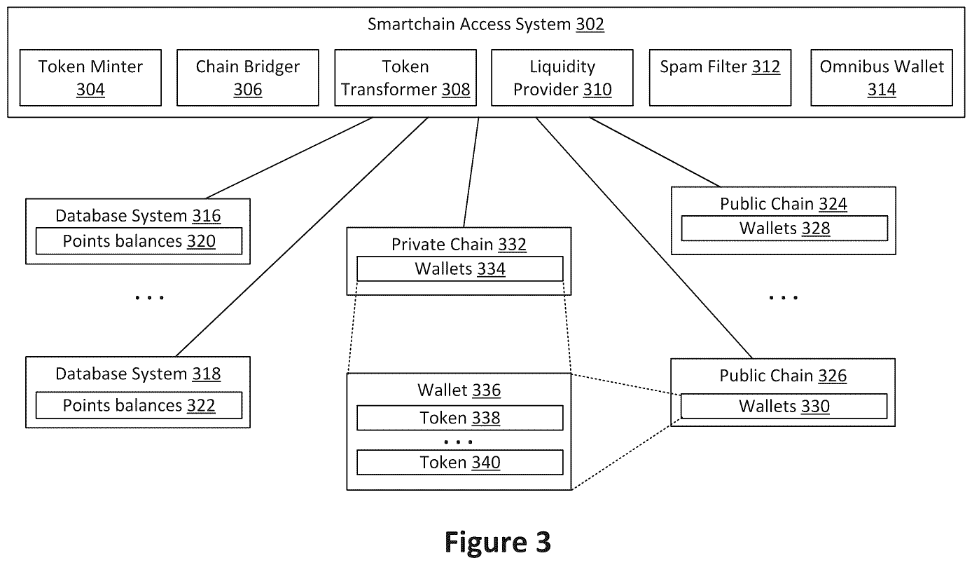

The centralized/token management system 102 includes a smartchain access system 302, which provides various types of functionality for accessing the various databases, public blockchains, and/or private blockchains employed by the centralized/token management system 102. Additional details regarding the smartchain access system 302 are discussed with respect to FIG. 3.

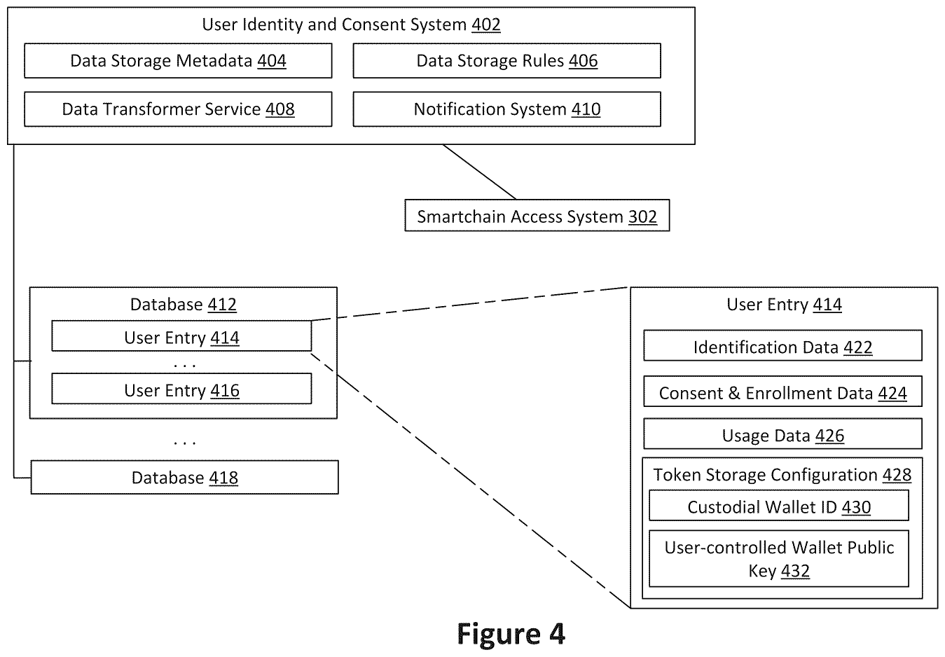

The centralized/token management system 102 also includes a user identity and consent system 402, which provides access to various operations for securely storing user information, communicating with users, authenticating users, securing user consent, and performing other such identity-related operations. Additional details regarding the member identity and consent system 402 are discussed with respect to FIG. 4.

FIG. 3 illustrates a smartchain access system 302, configured in accordance with one or more embodiments. The smartchain access system 302 includes a token minter 304, a chain bridger 306, a token transformer 308, a liquidity provider 310, a spam filter 312, and an omnibus wallet 314. The smartchain access system 302 provides access to the database systems 316 through 318, the public chains 324 through 326, and the private chain 332.

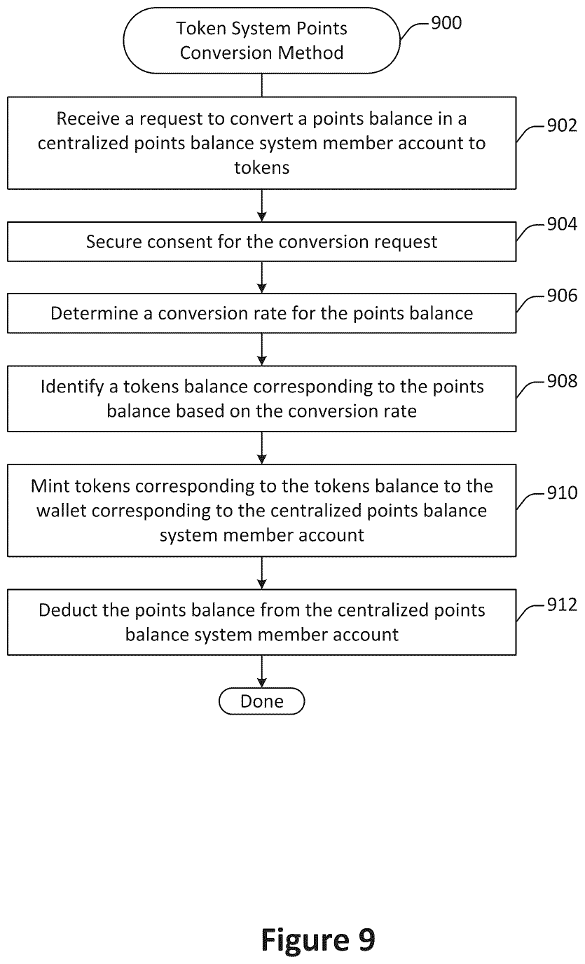

According to various embodiments, the token minter 304 facilitates the minting of tokens to any of the private chain 332 or the public chains 324 through 326. Such minting may be used, for instance, to transform tokens into points. Additional details regarding such operations are discussed throughout the application, for instance with respect to the method 900 shown in FIG. 9.

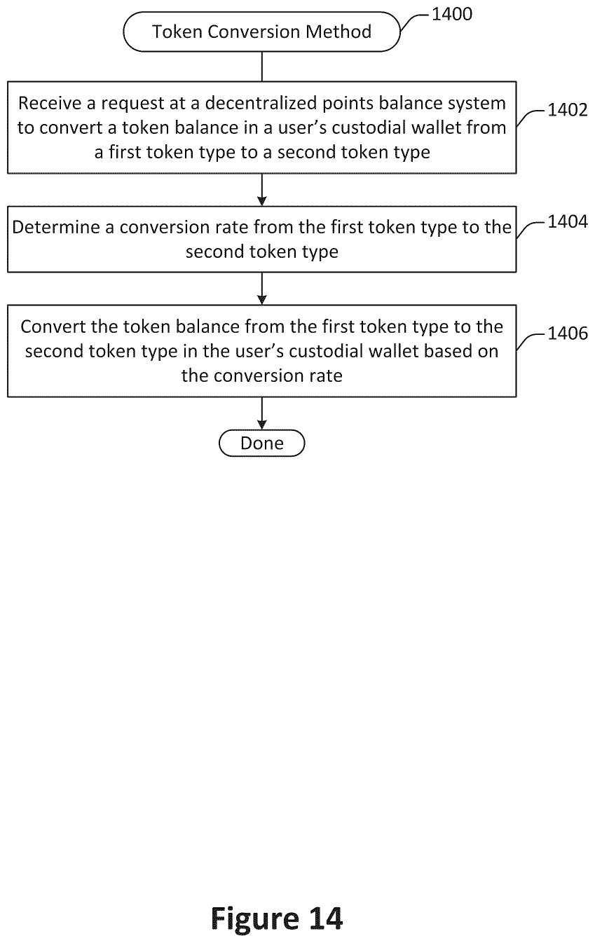

According to various embodiments, the chain bridger 306 facilitates the transfer of tokens between chains, such as between any of the private chain 332 or the public chains 324 through 326. Additional details regarding such operations are discussed throughout the application, for instance with respect to the method 1400 shown in FIG. 14.

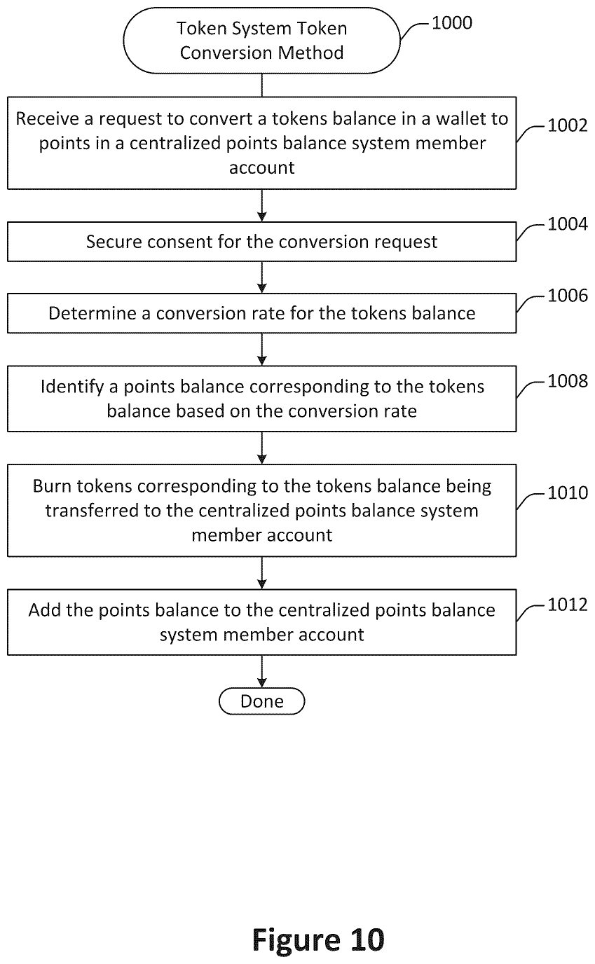

According to various embodiments, the token transformer 308 facilitates the transformation of tokens into points. For instance, tokens stored on one or more of the private chain 332 or the public chains 324 through 326 may be transformed into points balances stored in one or more of the database systems 316 through 318. Additional details regarding such operations are discussed throughout the application, for instance with respect to the method 1000 shown in FIG. 10.

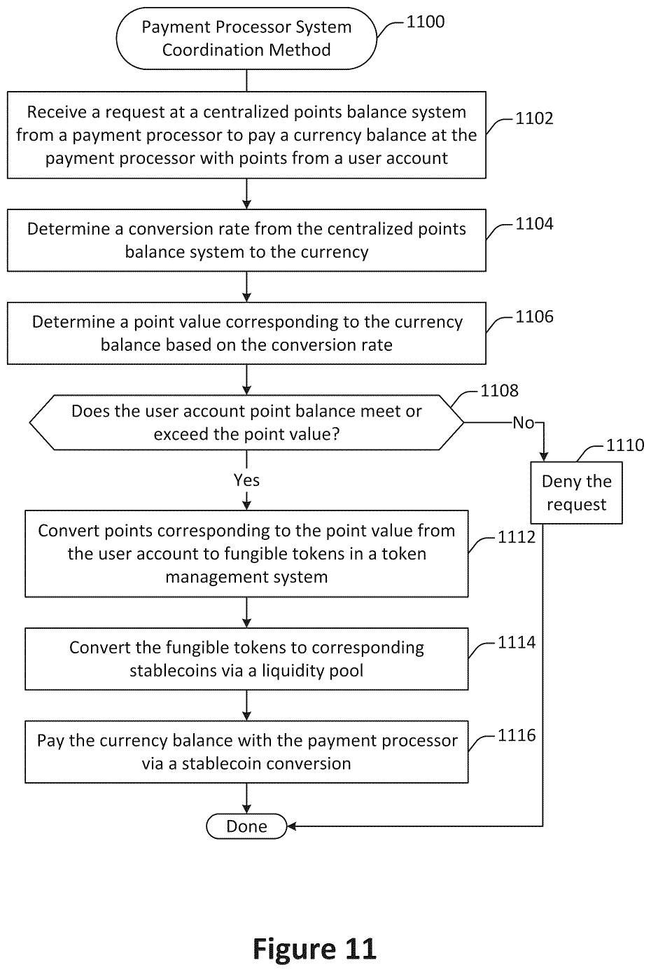

According to various embodiments, the liquidity provider 310 facilitates the payment of fiat currency balances via tokens and/or points. For instance, tokens stored on one or more of the private chain 332 or the public chains 324 through 326 may be first converted to stablecoins, after which the stablecoins may be applied to the fiat currency balances. Additional details regarding such operations are discussed throughout the application, for instance with respect to the method 1100 shown in FIG. 11.

According to various embodiments, the spam filter 312 helps to protect against unwanted inbound connections. For instance, the spam filter 312 may process inbound requests to help prevent airdropping unwanted tokens to wallets associated with the centralized/token management system 102.

According to various embodiments, the omnibus wallet 314 may be used to provide enhanced privacy and security. For instance, outbound transfers of tokens may pass through the omnibus wallet 314 so that a recipient of a token cannot observe the contents of the transferor's wallet that initially held the transferred token.

In some embodiments, the database systems 316 through 318 may be used to store points balances 320 through 322 for users of the system. A database system may be controlled by any of various parties. For example, a database system may be controlled by the service provider of the centralized/token management system 102, by a points issuer, or by a third-party service provider. Such points balances may be left intact or may be converted to tokens, as discussed herein.

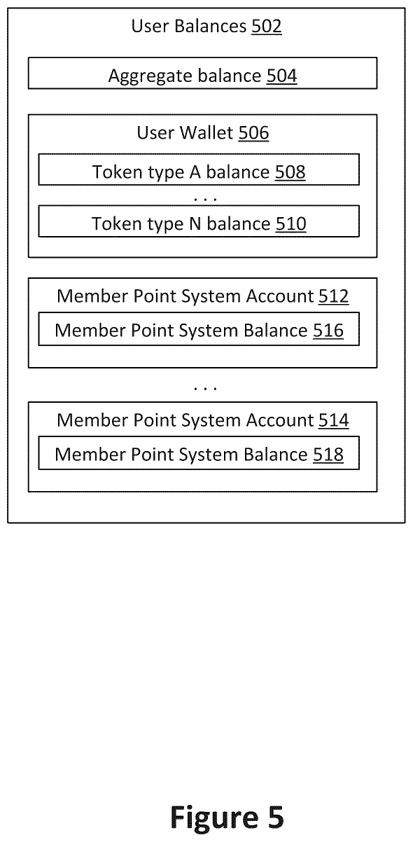

In some embodiments, one or more of the database systems 316 through 318 may store member balances that reflect not only points stored in the database system, but also points stored in other database systems and/or tokens stored on the blockchain. That is, one or more of the database systems 316 through 318 may store aggregate balance information used to facilitate efficient transaction processing. An example of such information is shown in FIG. 5.

In some embodiments, one or more user wallets 328 through 330 may be stored on one or more public chains. A public chain may be based on Ethereum, Bitcoin, Solana, Dogecoin, or any other suitable technology.

In some embodiments, one or more user wallets 334 may be stored on a private chain 332. The private chain 332 may be controlled by the service provider of the centralized/token management system 102.

According to various embodiments, storing tokens on the private chain 332 or one or more of the public chains 324 through 326 may provide any of various tradeoffs. The private chain 332 may be configured to be gasless, facilitating efficient and effectively costless transactions, whereas transactions performed on a public chain may be subject to a transaction fee. Also, the private chain 332 may be controlled by the service provider of the centralized/token management system 102, whereas one or more of the wallets 328 through 330 may be controlled by the token owner and stored in a decentralized ledger. Various configurations are possible. Depending on the configuration, tokens may or may not be directly visible to or accessed by end users.

According to various embodiments, an individual wallet 336 stored either on the private chain 332 or on the public chain 326 may store various numbers and types of tokens. For instance, tokens may be fungible or non-fungible. Non-fungible tokens (NFTs) may correspond, for instance, to specific rewards that are not directly transferrable to other tokens or usable to pay fiat currency balances.

FIG. 4 illustrates a user identity and consent system 402, configured in accordance with one or more embodiments. The user identity and consent system 402 includes data storage metadata 404, one or more data storage rules 406, a data transformer service 408, and a notification system 410.

According to various embodiments, the data storage metadata 404 stores information about where user entries are located. For instance, the data storage metadata 404 may indicate, for a particular user, which database of a set of databases stores user entry data for that user.

In some embodiments, the data storage rules 406 store information about where data is to be stored. For example, the data storage rules 406 may specify that data for users located within a particular geographic region must be stored within a database located within that geographic region.

In some embodiments, the token management system 102 may access one or more external services 206 to perform various functions. Examples of such external services including large language models or other AI systems.

In some embodiments, the token management system 102 may communicate with users via one or more messaging services 208. Examples of such messaging services include SMS services, email services, or other types of communication channels.

In some embodiments, the notification system 410 may be operable to share data with external systems, such as one or more CRM services 210. In the course of sharing such data, the data may be transformed by the data transformer service 408. For instance, transforming the data may involve adjusting the formatting or removing one or more personally identifying elements. The notification system 410 may also be configured to notify such external systems to delete such data, for instance upon request or revocation of consent by the user.

According to various embodiments, user entries 414 through 416 may be stored in one or more database systems 412 through 418. In some configurations, one or more user entry databases may be located inside the token management system 102. Alternatively, or additionally, one or more user entry databases may be stored outside the token management system 102. For instance, a database may be stored within a third-party cloud computing system (e.g., Amazon) or may be controlled by a points issuer. Such differences in database location may be driven by considerations such as restrictions on geographic locations in which personally identifying information may be stored.

The user entry 414 includes identification data 422, consent and enrollment data 424, usage data 426, and token storage configuration information 428. According to various embodiments, the identification data 422 may store personally identifying information such as a user's name, mailing address, and email address. The consent and enrollment data 424 stores information capturing the user's consent to enroll in the token management system 102 and/or various programs accessible via the token management system 102.

In some embodiments, the usage data 426 stores information about the user's use of the token management system 102, such as information about the user's usage of particular token and/or point management programs. For instance, the usage data 426 may store information indicating the user's expenditure of tokens or points accessible from within the token management system 102. Such data may be used to drive personalization, such as recommendations about tokens or offers that a user may be interested in.

In some embodiments, the token storage configuration information 428 stores information about where the user's tokens are stored. For example, the token storage configuration information 428 may store one or more custodial wallet IDs 430. A custodial wallet ID 430 uniquely identifies a custodial wallet managed by the token management system 102. As another example, the token storage configuration information 428 may store one or more public keys 432 for one or more user-controlled wallets.

In some embodiments, the user identity and consent system 402 is configured to communicate with the smartchain access system 302. For example, some information, such as user entry that is not personally identifying, may be stored on a blockchain. As another example, the smartchain access system 302 may be used to facilitate token swaps, liquidity generation, and/or other such operations.

FIG. 5 illustrates an example of a set of balances entries 502 for a user, configured in accordance with one or more embodiments. The balances entries 502 illustrate how the token management system 102 may support various balances across various types of tokens and point systems for a single user. For instance, a user may have point system balances 516 through 518 stored in member point system accounts 512 through 514. The user may also have one or more custodial or user-controlled wallets 506, which may store balances 508 through 510 of various types of tokens. As discussed herein, a token may be either fungible or non-fungible. An aggregate balance for the user's account may also be stored at 504. The aggregate balance may show, for instance, a total balance were the user's various fungible tokens and points converted into stablecoins.

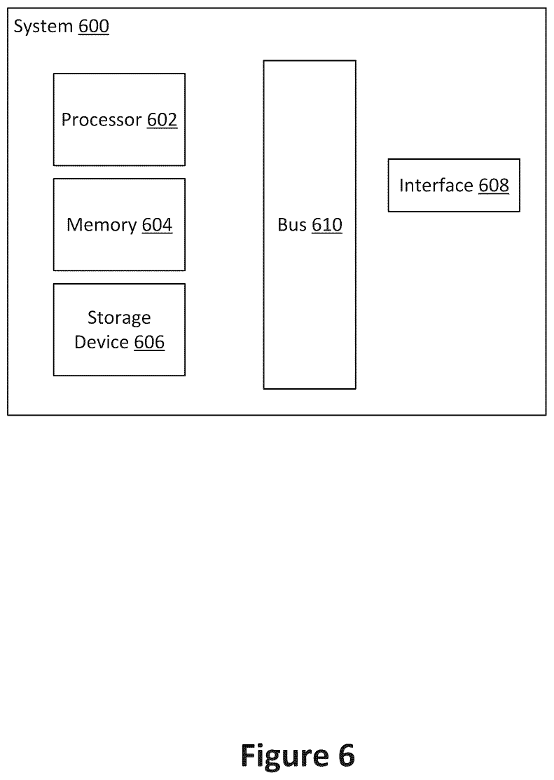

FIG. 6 illustrates one example of a computing device. According to various embodiments, a system 600 suitable for implementing embodiments described herein includes a processor 602, a memory module 604, a storage device 606, an interface 608, and a bus 610 (e.g., a PCI bus or other interconnection fabric.) System 600 may operate as variety of devices such as a client machine, a database server, a component within a token management system, or any other device or service described herein. Although a particular configuration is described, a variety of alternative configurations are possible. The processor 602 may perform operations such as those described herein. Instructions for performing such operations may be embodied in the memory 604, on one or more non-transitory computer readable media, or on some other storage device. Various specially configured devices can also be used in place of or in addition to the processor 602. The interface 608 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

### System Methodology

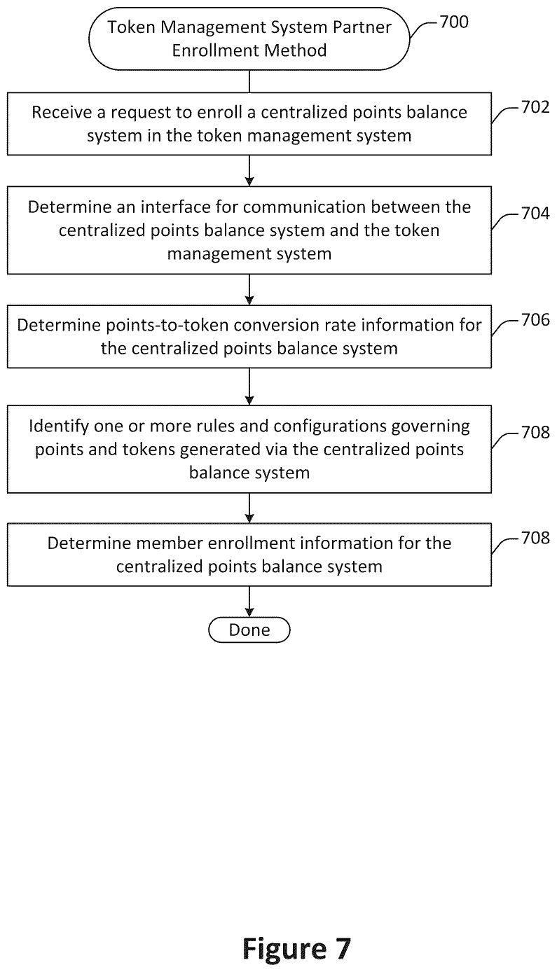

FIG. 7 illustrates a method 700 for enrolling a partner in a token management system, performed in accordance with one or more embodiments. The method 700 may be performed at the token management system 102 shown in FIG. 1. The method 700 may be performed in order to add a new points issuer to the system.

A request to enroll a centralized points balance system in the token management system is received at 702. In some embodiments, the request may be generated at the token management system 102, for instance by a systems administrator. The centralized points balance system may be associated with a computing system located outside of the token management system 102, such as the points issuer system 120.

An interface for communication between the centralized points balance system and the token management system is determined at 704. According to various embodiments, various types of interfaces may be supported. For example, the points issuer system 120 may be accessed via an application procedure interface.

Points-to-token conversion rate information is identified for the centralized balance system at 706. In some embodiments, the points-to-token conversion rate information may include one or more rules for converting balances from points stored in the centralized points balance system to tokens accessible via the token management system 102.

According to various embodiments, various points-to-token conversion rate information may be specified, depending on the configuration. For instance, a points-to-token conversion rate may be fixed. Alternatively, a variable rate may be defined, for instance based on a floating price associated with a given token.

One or more rules and configurations governing points and tokens generated via the centralized points balance system are identified at 708. For example, an airline may specify that its points may be converted to tokens, but those tokens cannot be spent on a competing airline outside of its rewards group. As another example, a points issuer may specify that its points may be associated with one multiplier (e.g., 2.5×) when used with one merchant or group of merchants, but another multiplier (e.g., 0.75×) when used with another merchant or group of merchants.

In some embodiments, one or more exclusions may be implemented by a smart contract. For instance, an exclusion may prevent swaps between specific tokens. An example of a metadata structure supporting such exclusions is as follows:
mapping (bytes32=>bytes32[ ]) public swapExclusions;

In some embodiments, one or more multipliers specified via a smart contract may boost token value during specific swaps. An example of a metadata structure supporting such a multiplier is as follows:
mapping (bytes32=>uint256) public swapMultipliers;

User enrollment information for the centralized points balance system is determined at 710. In some embodiments, the user enrollment information may characterize one or more processes or configuration options for enrolling users within the token management system 102. For example, points may be stored within the points issuer system 120 and converted to tokens at a specified rate upon request. As another example, points may be immediately transferred to tokens at a specified rate for consenting users.

In some embodiments, the member enrollment information may include a message for transmission to the members of the centralized points balance system, for instance via email or text message. The message may include an enrollment link to be used by the recipient to enroll within the token management system 102. The message may be sent by the points issuer system 120.

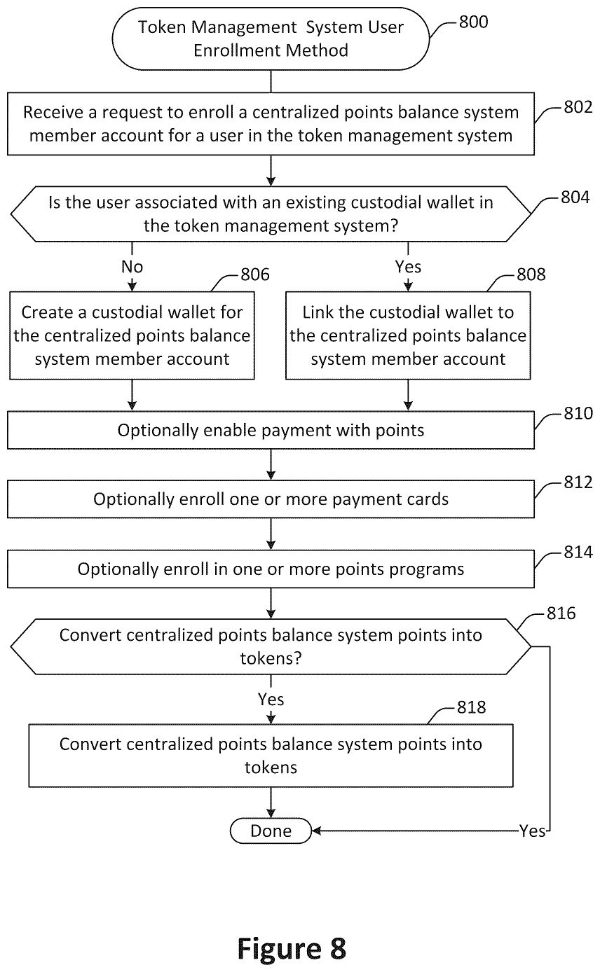

FIG. 8 illustrates a method 800 of enrolling a user in a token management system, performed in accordance with one or more embodiments. The method 800 may be performed at the token management system 102 shown in FIG. 1.

A request is received at 802 to enroll a centralized points balance system member account in the token management system 102. In some embodiments, the request may be received from a client machine. For instance, the user may receive an enrollment message generated as discussed with respect to operation 708. Clicking on a link included in the enrollment message may cause the user's client machine to transmit an enrollment request message to the token management system 102.

In some embodiments, the request may uniquely identify the user. For instance, the link included in the enrollment message may include an identify uniquely identifying the user within the centralized points balance system. This information in turn may allow the token management system 102 to determine at least some information about the user. Alternatively, or additionally, the user may provide personally identifying information, preference information, and/or other types of information as part of the enrollment process.

A determination is made at 804 as to whether the user is associated with an existing custodial wallet within the token management system. In some embodiments, the determination may be made based on information uniquely identifying the user, as discussed with respect to the operation 802. For instance, some users may be associated with an existing account, for example as a result of being previously enrolled in the centralized points balance system.

Upon determining that the user is associated with an existing custodial wallet, the custodial wallet is linked to the centralized points balance system user account at 808. For example, an existing user entry 414 for the user may be updated to reflect consent and enrollment of the user for the newly added centralized points balance system.

Upon determining instead that the user is not associated with an existing custodial wallet, a new custodial wallet is created for the centralized points balance system member account at 806. In some embodiments, the new custodial wallet may be created via the smartchain access system 302. Creating a new custodial wallet may also involve creating a new user entry data 414 that stores information identifying the newly created custodial wallet.

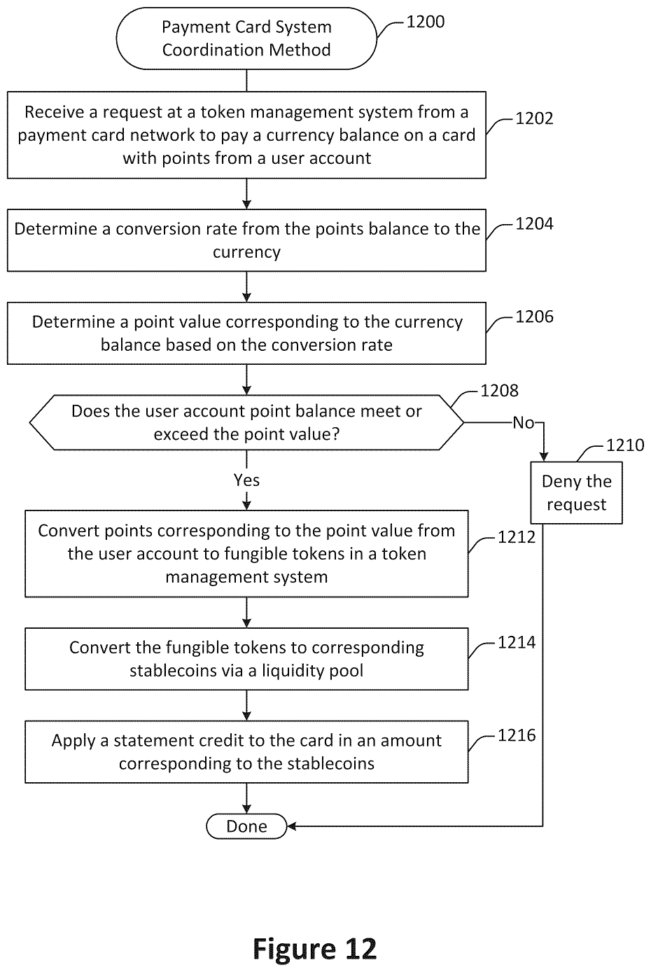

At 810, payment with points is optionally enabled. Techniques and mechanisms for payment with points are discussed throughout the application, for instance with respect to FIG. 11 and FIG. 12. The option to pay with points may be enabled based on one or both of user input and points issuer configuration information. For example, a points issuer may permit or disallow users to pay with points issued via the centralized points balance system. As another example, even if permitted by the points issuer, the user may in some configurations choose not to enable such an option.

At 812, the user optionally enrolls one or more payment cards in the token management system 102. In some embodiments, enrolling a payment card may involve operations such as providing a card identifier, a card expiration date, a card security code, a zip code, and/or other information. The payment card may be a credit card, a debit card, or another type of payment card.

The user account is optionally enrolled in one or more points programs at 814. In some embodiments, a points program may include points issued by a points issuer other than the one initially triggering the user's enrollment. The user may optionally enroll in such programs, facilitating increased interoperability of the user's points and tokens.

A determination is made at 816 as to whether to convert centralized points balance system points into tokens accessible via the token management system 102. In some embodiments, such a determination may be made for the user by the points issuer. For instance, the points issuer may make such a conversion a condition of enrollment, or may deny such an option to the user. Alternatively, or additionally, the user may decide whether to convert centralized points balance system points into tokens. For instance, the user may explicitly elect to take custody of the tokens by converting them into points.

In some embodiments, converting tokens to points may effectively transfer liability from the issuer/merchant balance sheet to the custodial wallet of the member, which may facilitate immediate point breakage and revenue recognition for the points issuer program.

Upon determining to convert centralized points balance system points into tokens, the conversion is performed at 818. Additional details regarding such a conversion are discussed with respect to the method 900 shown in FIG. 9.

FIG. 9 illustrates a method 900 for points conversion, performed in accordance with one or more embodiments. The method 900 may be performed at the token management system 102 in order to convert points associated with a centralized points issuer system to tokens accessible via the token management system 102.

In some embodiments, the system converts loyalty points into blockchain-based tokens (e.g., ERC-20 branded tokens or Stable Coins) using a smart contract. A token is tied to metadata. The metadata may include, but is not limited to: (1) a source loyalty program identifier; (2) a conversion rate; (3) a timestamp of issuance; (4) a liability transfer status; (5), one or more swap exclusions, multipliers, and/or fees (if applicable); and/or (6) swap fees (e.g., applied by the source program and/or the platform). Thus, information characterizing the use of the token may be maintained for subsequent transactions by storing such information along with the token stored in the user's wallet.

In some embodiments, to ensure compliance with accounting standards, the system includes a mechanism for transferring point liability from the loyalty program's balance sheet to the blockchain, and subsequently to the user. For example, the loyalty program may transfer liability to the blockchain using the transferLiability function within the smart contract when points are converted to tokens. As another example, a liability redemption function may be used to mark the liability as redeemed when tokens are used or expired. To accomplish such transfer, the smart contract maintains a registry of liability records. The information stored in such records may include, but is not limited to: (1) the source program; (2) the amount of liability transferred; (3) the timestamp; and/or (4) the redemption status.

A request is received to convert a points balance in a centralized points balance system member account to tokens. In some embodiments, the request may be generated as discussed with respect to the operation 818 shown in FIG. 8. Alternatively, the request may be generated in a different way. For instance, the user may access the token management system 102 after enrollment and submit a separate request to perform such a conversion.

Consent for the conversion request is secured at 904. According to various embodiments, the specific mechanism for consent may depend on the system configuration. For example, consent may be secured via a click-through contract.

In some embodiments, user consent may be recorded via a cryptographic signature. For instance, a consent message can be generated. The consent message may include information such as: (1) the user wallet address; (2) the points being converted; (3) a liability acknowledgment statement; (4) a timestamp; and/or (5) a conversion rate set by source program (transferee). The user may then sign the message with their private key to accept liability for points being redeemed for tokens or other items. Next, the smart contract verifies the signature using the ecrecover function and records the consent as metadata. An example metadata structure for supporting such an operation is as follows. Using this process, consent may be recorded as an immutable and auditable record.

```
struct UserConsent {
  address user;
  bytes32 signedMessageHash;
  uint256 pointsRedeemed;
  uint256 timestamp;
}
mapping (address => UserConsent) public consentRegistry;
In some embodiments, a verification workflow may be configured as follows:
function recordConsent (address user, uint256 points, bytes32 messageHash, uint8 v,
bytes32 r,bytes32 s) public {
  require (verifyConsent (user, points, messageHash, v, r, s), “Invalid signature”);
  consentRegistry[user] = UserConsent ({user: user, signedMessageHash:
  messageHash, pointsRedeemed: points, timestamp: block.timestamp);
  emit ConsentRecorded (user, points, block.timestamp);
}
```

A conversion rate for the points balance conversion is determined at 906. In some embodiments, a point value conversion rate may be fixed at the time of enrollment of the centralized points balance system, for instance by the points issuer. Alternatively, point value conversion rate may be determined dynamically at the time of conversion, for instance based on a floating token value. For instance, a smart contract may query a token pool for an appropriate conversion rate.

In some embodiments, the system may support token swap fees. Fees may be dynamically applied based on predefined rules set by source program. Also, one or more token swap fees may be applied by the platform provider. For example, a 5% fee may be applied when swapping Program A tokens (e.g., LPT_A) to stablecoins (USDC, USDT, etc). As another example, a different fee may be applied when swapping Program A tokens (e.g., LPT_A) to Program B tokens (e.g., LPt_B). The size of the token swap fee and the party who pays the token swap fee may be specified by the points issuer. As yet another example, the points issuer may specify that a merchant receiving a payment is responsible for a transaction fee.

A tokens balance corresponding to the points balance is identified at 908 based on the conversion rate. In some embodiments, determining the tokens balance may involve first determining a points balance for the user and then multiplying the points balance by the conversion rate. In some situations, the user may seek to convert all of the user's points to tokens. Alternatively, the user may convert only a portion of the user's points balance. Information regarding the points balance may be determined based on user input and/or points balance information stored in one or more of the database systems 316 through 318.

At 910, one or more tokens are minted corresponding to the tokens balance. The tokens may be mined to the wallet corresponding to the centralized points balance system member account. As discussed with respect to the token storage configuration information 428, the recipient wallet may be either a custodial wallet 430 controlled by the token management system 102 or a user-controlled wallet accessed via the wallet public key 432. The tokens may be minted via the token minter 304.

In some embodiments, a minted token may include one or more metadata elements. Examples of such information may include, but are not limited to: (1) the user's wallet address; (2) a signed message hash; (3) a timestamp of consent; (4) one or more points converted and fiat point value; (5) source program currency and conversion rate to USD; and (6) USDC & USDT converted value.

The points balance is deducted from the centralized points balance system member account at 912. In some embodiments, deducting the points balance may involve communicating with one or more of the database systems 316 through 318.

In some embodiments, one or more of the operations discussed with respect to FIG. 9 may be performed by a smart contract. The smart contract may include a function to convert loyalty points into tokens and release the liability, such as the following function:

```
    function convertPointsToTokens ( ) public {
    require (loyaltyPointsBalance[msg.sender] >0, “No points to convert.”);
    require (!liabilityTransferred[msg.sender], “Liability already transferred.”);
    uint256 tokensToMint = loyaltyPointsBalance[msg.sender]/
  conversionRate;
    require (tokensToMint > 0, “Insufficient points for conversion.”);
    //Mint tokens to user’s wallet_
    mint (msg.sender, tokensToMint);
    //Clear loyalty points balance
    loyaltyPointsBalance[msg.sender] = 0;
    //Mark liability as transferred
    liabilityTransferred[msg.sender] = true;
    //Emit event for audit
    emit TokensIssued (msg.sender, tokensToMint, block.timestamp);
  }
```

In some embodiments, the smart contract may maintain a list of all users whose liabilities have been transferred. An example of such a list along with a function for updating it are as follows. Such a function may be executed at 912 when the points balance is deducted from the centralized points balance system member account.

address[ ] public liabilityTransferredUsers;
function recordLiabilityTransfer (address user) internal {
liabilityTransferredUsers.push (user);
}

According to various embodiments, a smart contract may include one or more metadata elements and/or functions to clarify that ownership and liability for the tokens are now with the end user after the points have been converted to tokens.

In some embodiments, the user's wallet address must hold exclusive ownership of the tokens upon conversion. Such metadata may be updated upon token creation. An example of such metadata is as follows:
mapping(address=>uint256) public tokenBalance;
In some embodiments, a smart contract may include metadata to confirm that tokens have been issued and transferred to the user. Such metadata may be updated upon token creation. An example of such metadata is as follows:

event TokensIssued (address indexed user,
uint256 amount, uint256 timestamp);

For example, when points are converted, the contract can emit an event to record the transaction. An example of such an event is as follows:
emit TokensIssued(msg.sender, tokensToMint, block.timestamp);

In some embodiments, a smart contract includes a record of liability transfer per user to confirm that the company has fulfilled its obligation. An example of such metadata is as follows:
mapping(address=>bool) public liabilityTransferred;

During the conversion process, this field can be updated, for instance as follows:
liabilityTransferred [msg.sender]=true;

In some embodiments, a smart contract may include metadata or a flag explicitly stating that the company no longer has any obligation for the tokens. An example of such an entry is as follows:
bool public liabilityReleased;

This flag can be set to True globally upon conversion to clearly release the company from future liabilities. For instance, a smart contract may include a function such as the following to support such an operation:

function releaseLiability ( ) internal {
liabilityReleased = true;
}

In some embodiments, a method such as that shown in FIG. 9 may facilitate the redemption of points for digital objects or badges. Such When users redeem points directly for non-cost-based items, liquidity pools may be bypassed. For example, a user redeems 100 points for a tokenized badge. An example of a workflow for such an operation is as follows:

```
function redeemForObject (address user, uint256 points, string memory objectld)
public onlyProgram {
  require (balanceOf (user) >= points, “Insufficient points”);
  //Burn points_
  burn (user, points);
  //Reduce liability
  reduceLiability (points);
  emit ObjectRedeemed (user, points, objectld, block.timestamp);
}
```

In some embodiments, points may be converted into entries for sweepstakes, represented as tokens. An example of such a workflow is as follows:

```
function redeemForSweepstakes (address user, uint256 points, string memory
sweepstakesld) public onlyProgram {
  require (balanceOf (user) >= points, “Insufficient points”);
  //Burn points_
  burn (user, points);
  //Reduce liability
  reduceLiability (points);
  emit SweepstakesEntered (user, points, sweepstakesld, block.timestamp);
}
```

In some embodiments, the system may facilitate accounting for non-cost-based redemptions. For example, in such situations, liability may be reduced immediately upon redemption since no financial obligation remains.

FIG. 10 illustrates a method 1000 for converting tokens stored in the token management system 102 to points stored in a centralized points balance system member account. At 1002, a request is received to convert a tokens balance in a wallet to points in a centralized points balance system member account. Consent for the conversion request is secured at 1004. A conversion rate is determined for the tokens balance is determined at 1006. A points balance corresponding to the tokens balance is determined at 1008 based on the conversion rate. Tokens corresponding to the tokens balance being transferred to the centralized points balance system member account are burned at 1010. The points balance is added to the centralized points balance system member account at 1012. According to various embodiments, the operations performed as discussed with respect to the method 1000 may be substantially similar to the operations discussed with respect to the method 900 shown in FIG. 9.

FIG. 11 illustrates a method 1100 of coordinating communication with a payment processor system, configured in accordance with one or more embodiments. The method 1200 may be performed at the token management system 102 shown in FIG. 1.

For example, a user may decide to use loyalty points from a merchant loyalty point program to pay for a purchase from a different vendor. To make this example more concrete, 500 points from a vendor loyalty program may be converted to 500 ERC-20 fungible vendor-branded tokens on the blockchain. The 500 tokens are then swapped to a stablecoin providing a balance of $5 USD using a liquidity pool. Then, $5 USD is spent on a purchase using a payment processor (e.g., Stripe) that accepts stablecoins as payment.

At 1102, a request is received at a token management system from a payment processor system to a pay a currency balance at the payment processors with points and/or tokens from a user's account. The payment processor may be, for example, a service such as stripe. The currency balance may correspond to a purchase at the payment processor. The request may be received at the application interface 116 shown in FIG. 1.

A conversion rate from the points balance to the currency is determined at 1104. According to various embodiments, as discussed herein, the conversion rate may be dynamically determined. Alternatively, a static conversion rate may be set. In some configurations, the conversion rate may be subject to a multiplier based on one or more predetermined rules set by the points issuer. Such information may be retrieved from the token management system 102.

A point value corresponding to the currency balance is determined at 1106 based on the conversion rate. In some embodiments, the point value may be determined by multiplying the currency balance by the conversion rate.

A determination is made at 1108 as to whether the user account point balance meets or exceeds the point value. In some embodiments, the determination may be made by accessing a corresponding balance within the user balances 502.

In some embodiments, a user may be provided with the option to select one or more balances with which to complete the transaction. For example, a user may be able to select a token type or points issuer program if more than one balance is available. As another example, a user may be able to combine multiple token types and/or points issuer programs, for instance if the balance in one account or token type is insufficient to cover the transaction.

Upon determining that the user lacks sufficient points, the request is denied at 1110. Upon determining instead that the user's point balance is sufficient, points corresponding to the point value are converted from the user account to fungible tokens in a token management system. Operations for performing such a conversion are discussed with respect to the method 900 shown in FIG. 9.

The fungible tokens are converted to stablecoins via a liquidity pool at 1114. In some embodiments, a stablecoin may be tied to the value of fiat currency, such as the United States dollar. The stablecoin may therefore provide a basis for transaction with merchants and payment processors that conduct business in fiat currency. The liquidity pool may be a reserve of stablecoins accessible to the token management system 102 for use in facilitating transactions.

The currency balance is paid with the payment processor via a stablecoin conversion at 1116. In some embodiments, the payment may involve transferring the stablecoins determined at 1114 to the payment processor. Alternatively, the stablecoins may be directly redeemed for corresponding fiat currency deposited into an account of the payment processor.

FIG. 12 illustrates a method 1200 of coordinating communication with a payment card system, performed in accordance with one or more embodiments. The method 1200 may be performed at the token management system 102 shown in FIG. 1.

For example, the method 1200 may be used to issue $2.70 statement credit is issued to a user. To effect this transaction, 400 merchant loyalty points are converted to $2.70 USDC stablecoins using a liquidity pool. Then, $2.70 USDC stablecoins is deducted to refund the transaction on the enrolled credit or debit card using statement credit.

At 1202, a request is received at a token management system from a payment card network to a pay a currency balance on a payment card with points from a user's account. For instance, the currency balance may correspond to a purchase via a credit card or debit card. The request may be received at the application interface 116 shown in FIG. 1.

A conversion rate from the points balance to the currency is determined at 1204. A point value corresponding to the currency balance is determined at 1206 based on the conversion rate. A determination is made at 1208 as to whether the user account point balance meets or exceeds the point value. Upon determining that the user lacks sufficient points, the request is denied at 1210. Upon determining instead that the user's point balance is sufficient, points corresponding to the point value are converted from the user account to fungible tokens in a token management system. The fungible tokens are converted to stablecoins via a liquidity pool at 1214. According to various embodiments, the operations 1202 through 1216 may be substantially similar to the operations 1102 through 1116, with the exception that the request is received at 1202 from a payment card network rather than a merchant.

A statement credit is applied to the card in an amount corresponding to the stablecoins at 1216. In some embodiments, applying the statement credit may involve operations such as transferring the stablecoins to the service provider of the payment card network, which may then reduce the user's payment card balance by the corresponding amount.

In some embodiments, as discussed with respect to the methods 900, 1100, and 1200, the system may support dynamic point-to-token conversion. For instance, points (e.g., LPT_A) can be swapped into other tokens (e.g., LPT_B) or stablecoins through a decentralized liquidity pool. Conversion rates may be managed dynamically via a formula such as a constant product formula (e.g., x*y=k).

In some embodiments, to perform such a conversion, a user may select a swap option (e.g., LPT_A→LPT_B). Then, the smart contract queries a liquidity pool for real-time pricing. Next, tokens are transferred to the user's wallet, and liability is transferred to the blockchain.

In some embodiments, a smart contract workflow may be implemented via a function such as the following:

```
function swapLPT (address user, uint256 amount, address tokenOut) public {
  //Verify user’s balance
  require (balanceOf (user) >= amount, “Insufficient balance”);
  //Get conversion rate from liquidity pool
  uint256 conversionRate = getConversionRate (tokenOut);
  //Calculate tokens to issue
  uint256 tokensToMint = amount * conversionRate;
  //Transfer tokens
  burn(user, amount); //Burn LPT_A
  mint (user, tokensToMint); //Mint LPT_B or stablecoin
  emit TokenSwapped (user, amount, tokenOut, tokensToMint);
}
```

In some embodiments, a swap transaction is recorded with metadata, such as the following:

```
struct SwapMetadata {
  address user;
  uint256 amountin;
  address tokenOut;
  uint256 amountOut;
  uint256 timestamp;
}
```

mapping(bytes32=>SwapMetadata) public swapRecords;

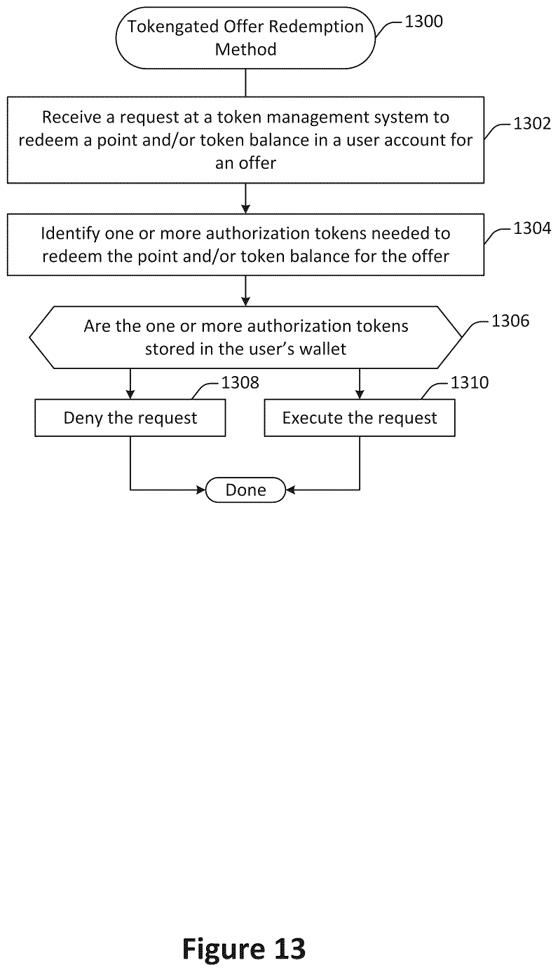

FIG. 13 illustrates a method 1300 of redeeming a token-gated offer, performed in accordance with one or more embodiments. The method 1300 may be performed at the token management system 102 shown in FIG. 1.

For example, a vendor's points and/or tokens can be redeemed in the vendor's marketplace for pre-approved 3rd party merchant-sponsored offers. The vendor's tokens can then be converted to USD for merchant purchases via a credit/debit card network. The acceptance of such an offer may require that the user possess a predetermined authorization token.

A request is received at a token management system to redeem a point and/or token balance in a user account for an offer. In some embodiments, the request may be received at the application interface 116 shown in FIG. 1. The request may include a unique identifier corresponding to the token-gated offer.

One or more authorization tokens needed to redeem the point and/or token balance for the offer are identified at 1304. In some embodiments, a token-gated offer refers to a transaction that requires, as a prerequisite, that the user first possess a designated token, such as an NFT issued by a points issuer. Such a token may be identified based on the unique identifier included with the request.

A determination is made at 1306 as to whether the one or more authorization tokens are stored in the user's wallet. In some embodiments, the determination may involve accessing the user's wallet to check for the presence of the one or more authorization tokens.

Upon determining at that the one or more authorization tokens are not stored in the user's wallet, the request is denied at 1308. Upon determining instead that the one or more authorization tokens are stored in the user's wallet, the request is executed at 1310.

In some embodiments, executing the request at 1310 may involve performing one or more operations for transferring tokens and/or points from the user's account, for instance as discussed with respect to the methods 1100, 1200, 1400, and 1500.

In some embodiments, executing the request at 1310 may involve removing the one or more authorization tokens from the user's wallet. For instance, the one or more authorization tokens may be burned or transferred to a different wallet.

FIG. 14 illustrates a token conversion method 1400, performed in accordance with one or more embodiments. The method 1400 may be performed at the token management system 102. The token conversion method may be performed to convert tokens from a first token type to a second token type.

A request is received at 1502 to convert a token balance in a user's custodial wallet from a first token type to a second token type. Such a transfer may be intended to facilitate a subsequent transaction in the second token type. In some embodiments, the request may be received at the web application wallet interface 218 shown in FIG. 2.

A conversion rate from the first token type to the second token type is determined at 1404. For instance, 300 tokens of the first token type may correspond to 100 tokens of the second token type at a 3-to-1 conversion rate. As discussed herein, such a conversion type may be static, for instance specified based on input from a points issuer. Alternatively, such a conversion may be dynamic, for instance dependent on one or more floating token rates.

The tokens balance is converted from the first token type to the second token type at 1404. In some embodiments, converting the tokens may involve burning a quantity of the first token type and minting a quantity of the second token type. Such operations may be performed by the token minter 304.

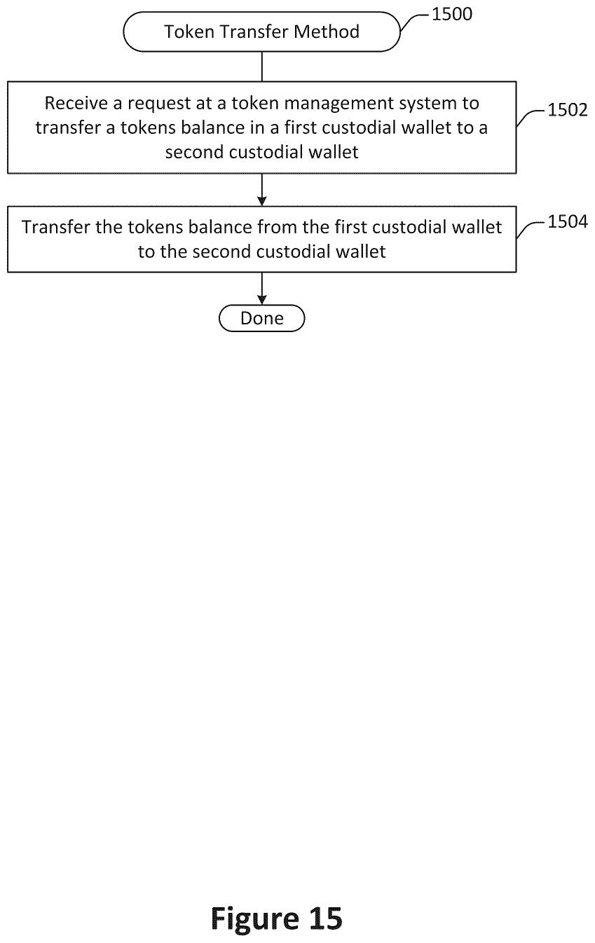

FIG. 15 illustrates a token transfer method 1500, performed in accordance with one or more embodiments. The token transfer method may be performed to transfer tokens between wallets.

A request is received at 1502 to transfer a tokens balance in a first custodial wallet to a second custodial wallet within a token management system. Such a transfer may be to facilitate a gift or to facilitate a transaction that occurs outside of the token management system 102. In some embodiments, the request may be received at the web application wallet interface 218 shown in FIG. 2.

The tokens balance is transferred from the first custodial wallet to the second custodial wallet at 1504. In some embodiments, the token transfer may be performed via the smartchain access system 302.

### Metadata Summary

As discussed herein, a smart contract can include various types of metadata and functionality. Some such metadata and functionality has been discussed throughout the application as filed. However, discussion of other metadata and functionality has been omitted to avoid obscuring the inventive concepts. This section describes additional examples of such metadata and functionality, configured in accordance with one or more embodiments.

In some embodiments, a smart contract may include metadata to establish clarity and transparency about liability transfer. For example, the smart contract may include a record the exact time the liability was transferred, for instance as follows:
mapping(address=>uint256) public conversionTimestamp;

As another example, the smart contract may include a record of when points are converted, for instance as follows:
conversionTimestamp[msg.sender]=block.timestamp;

As yet another example, the smart contract may maintain a log of all conversions for audit purposes, for instance as follows:

event LiabilityTransferred (address indexed user,
uint256 amount, uint256 timestamp);

In some embodiments, for instance if tokens can be redeemed for goods/services, a smart contract may record whether they have been redeemed to avoid any future obligations. An example of such an entry is as follows:
mapping(address=>bool) public tokensRedeemed;

In some embodiments, additional fields can be included, for instance to ensure liability transfer aligns with legal and business considerations. For example, a metadata field may encode the terms under which the liability is transferred, for instance as follows:
string public termsOfLiabilityTransfer;

An example of a data value for such a field is as follows:
termsOfLiabilityTransfer=“By converting loyalty points to tokens, the user assumes full ownership and responsibility for the tokens, and the company releases all associated obligations.”;

As another example, a smart contract may include functionality to require user acknowledgment before conversion. An example of such a metadata entry and associated function is as follows:

mapping (address => bool) public userAcknowledged;
function acknowledgeTerms ( ) public {
userAcknowledged[msg.sender] = true;
}

As still another example, a smart contract may require acknowledgment before allowing conversion. An example implementation of such a requirement is as follows:

require (userAcknowledged[msg.sender], “User must
acknowledge terms before conversion.”);

The following table provides a non-exhaustive list of the types of metadata that may be included in a smart contract in accordance with one or more embodiments.

| Metadata | Purpose |
|---|---|
| address => uint256 | Tracks users' loyalty points before |
| loyaltyPointsBalance | conversion. |
| address => uint256 | Tracks token balances post-conversion. |
| tokenBalance | |
| uint256 conversionRate | Specifies the points-to-token exchange |
| | rate. |
| mapping(address => bool) | Records whether the company's |
| liabilityTransferred | liability has been transferred to the |
| | user. |
| bool liabilityReleased | Global flag indicating that the company |
| | has no remaining obligations. |
| mapping(address => uint256) | Tracks the timestamp of the liability |
| conversionTimestamp | transfer. |
| event LiabilityTransferred | Logs every instance of liability transfer |
| | for transparency. |
| string termsOfLiabilityTransfer | Encodes the terms of liability transfer. |
| mapping(address => bool) | Ensures users agree to liability transfer |
| userAcknowledged | terms before conversion. |

### CONCLUSION

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities. As used herein, the term “multiple” refers to two or more.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of particular blockchain configurations. However, the techniques disclosed herein apply to a wide variety of blockchain configurations. Particular embodiments may be implemented without some or all of the specific details described herein. In other instances, well-known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A cloud computing system comprising:
a database system storing a plurality of user entries including identification data corresponding to a plurality of user accounts within the cloud computing system;
a communication interface in communication with a plurality of external database systems, an external database system of the plurality of external database systems storing a plurality of database entries corresponding to a subset of the plurality of user accounts;
an access system providing access to a private blockchain and a plurality of public blockchains, the private blockchain storing a plurality of wallets corresponding to the plurality of users, the access system being configured to mint a first one or more tokens of a first token type to a wallet of the plurality of wallets based on a value stored in a database entry of the plurality of database entries, the wallet and the database entry each corresponding to a designated user account of the plurality of user accounts, the access system being configured to update the value stored in the database entry upon minting of the one or more tokens, the access system being configured to convert a portion of the first one or more tokens to a second one or more tokens of a second token type, the access system being configured to transfer the second one or more tokens to a designated recipient located outside of the cloud computing system; and
a consent management system configured to transmit a confirmation message to a client machine associated with the designated user account upon receiving a request to mint the first one or more tokens of the first token type, to receive from the client machine a cryptographic signature of the confirmation message, and to record the cryptographic signature in the private blockchain via the access system.

2. The cloud computing system recited in claim 1, wherein the access system is configured to store a plurality of auditing records on the private blockchain, the plurality of auditing records reflecting one or more transactions performed via the access system.

3. The cloud computing system recited in claim 1, wherein converting the portion of the first one or more tokens to the second one or more tokens comprises determining that converting the portion of the first one or more tokens to the second one or more tokens does not violate one or more transfer exclusions restricting transfers of the first token type.

4. The cloud computing system recited in claim 1, wherein converting the portion of the first one or more tokens to the second one or more tokens comprises determining a conversion rate, the conversion rate including a multiplier between the first token type and the second token type.

5. The cloud computing system recited in claim 4, wherein the conversion rate is specified by a service provider of the external database system.

6. The cloud computing system recited in claim 4, wherein converting the portion of the first one or more tokens to the second one or more tokens comprises communicating with a decentralized stablecoin pool to determine the conversion rate.

7. The cloud computing system recited in claim 4, wherein the conversion rate is specified by a service provider of the external database system.

8. The cloud computing system recited in claim 1, wherein converting the portion of the first one or more tokens to the second one or more tokens of a second token type comprises: (1) executing a token transfer function within a smart contract, and (2) executing a liability transfer function within the smart contract to transfer accounting liability for the first one or more tokens from a service provider of the external database system to the designated user account.

9. The cloud computing system recited in claim 1, wherein converting the portion of the first one or more tokens to the second one or more tokens of a second token type comprises determining whether the wallet is storing an authorization token authorizing converting the first token type to the second token type and converting the portion of the first one or more tokens to the second one or more tokens upon determining that the wallet is storing the authorization token.

10. The cloud computing system recited in claim 1, wherein minting the first one or more tokens of the first token type comprises: (1) executing a minting function within a smart contract, and (2) executing a liability transfer function within the smart contract to transfer accounting liability for the first one or more tokens from a service provider of the external database system to the designated user account.

11. The cloud computing system recited in claim 1, wherein transferring the second one or more tokens to the designated recipient located outside of the cloud computing system comprises transferring the second one or more tokens to an omnibus wallet controlled by cloud computing system and transferring the second one or more tokens from the omnibus wallet to the designated recipient.

12. The cloud computing system recited in claim 1, wherein the second one or more tokens are stored on a public blockchain.

13. The cloud computing system recited in claim 1, wherein the second token type is a non-fungible token.

14. A method implemented in a cloud computing system, the method comprising:
storing a plurality of user entries including identification data corresponding to a plurality of user accounts in a database system within the cloud computing system;
conducting communications with a plurality of external database systems via a communication interface, an external database system of the plurality of external database systems storing a plurality of database entries corresponding to a subset of the plurality of user accounts;
accessing a private blockchain and a plurality of public blockchains via an access system, the private blockchain storing a plurality of wallets corresponding to the plurality of users, the access system being configured to mint a first one or more tokens of a first token type to a wallet of the plurality of wallets based on a value stored in a database entry of the plurality of database entries, the wallet and the database entry each corresponding to a designated user account of the plurality of user accounts, the access system being configured to update the value stored in the database entry upon minting of the one or more tokens, the access system being configured to convert a portion of the first one or more tokens to a second one or more tokens of a second token type, the access system being configured to transfer the second one or more tokens to a designated recipient located outside of the cloud computing system; and
communicating with a client machine associated with the designated user account via a consent management system, wherein the communication includes transmitting a confirmation message to the client machine upon receiving a request to mint the first one or more tokens of the first token type, receiving from the client machine a cryptographic signature of the confirmation message, and recording the cryptographic signature in the private blockchain via the access system.

15. The method recited in claim 14, wherein converting the portion of the first one or more tokens to the second one or more tokens of a second token type comprises: (1) executing a token transfer function within a smart contract, and (2) executing a liability transfer function within the smart contract to transfer accounting liability for the first one or more tokens from a service provider of the external database system to the designated user account.

16. The method recited in claim 14, wherein converting the portion of the first one or more tokens to the second one or more tokens of a second token type comprises determining whether the wallet is storing an authorization token authorizing converting the first token type to the second token type and converting the portion of the first one or more tokens to the second one or more tokens upon determining that the wallet is storing the authorization token.

17. The method recited in claim 14, wherein minting the first one or more tokens of the first token type comprises: (1) executing a minting function within a smart contract, and (2) executing a liability transfer function within the smart contract to transfer accounting liability for the first one or more tokens from a service provider of the external database system to the designated user account.

18. One or more non-transitory computer readable media having instructions stored thereon for performing a method implemented in a cloud computing system, the method comprising:
storing a plurality of user entries including identification data corresponding to a plurality of user accounts in a database system within the cloud computing system;
conducting communications with a plurality of external database systems via a communication interface, an external database system of the plurality of external database systems storing a plurality of database entries corresponding to a subset of the plurality of user accounts;
accessing a private blockchain and a plurality of public blockchains via an access system, the private blockchain storing a plurality of wallets corresponding to the plurality of users, the access system being configured to mint a first one or more tokens of a first token type to a wallet of the plurality of wallets based on a value stored in a database entry of the plurality of database entries, the wallet and the database entry each corresponding to a designated user account of the plurality of user accounts, the access system being configured to update the value stored in the database entry upon minting of the one or more tokens, the access system being configured to convert a portion of the first one or more tokens to a second one or more tokens of a second token type, the access system being configured to transfer the second one or more tokens to a designated recipient located outside of the cloud computing system; and
communicating with a client machine associated with the designated user account via a consent management system, wherein the communication includes transmitting a confirmation message to the client machine upon receiving a request to mint the first one or more tokens of the first token type, receiving from the client machine a cryptographic signature of the confirmation message, and recording the cryptographic signature in the private blockchain via the access system.

19. The one or more non-transitory computer readable media recited in claim 18, wherein converting the portion of the first one or more tokens to the second one or more tokens of a second token type comprises: (1) executing a token transfer function within a smart contract, and (2) executing a liability transfer function within the smart contract to transfer accounting liability for the first one or more tokens from a service provider of the external database system to the designated user account.

20. The one or more non-transitory computer readable media recited in claim 18, wherein converting the portion of the first one or more tokens to the second one or more tokens of a second token type comprises determining whether the wallet is storing an authorization token authorizing converting the first token type to the second token type and converting the portion of the first one or more tokens to the second one or more tokens upon determining that the wallet is storing the authorization token.
